(19) United States
(12) Patent Application Publication
(10) Pub. No.: US 2007/0144430 A1
(43) Pub. Date: Jun. 28, 2007

(54) POWDER COATING BOOTH

(76) Inventor: Leopold VON KEUDELL, Salem (DE)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/566,792

(22) Filed: Dec. 5, 2006

(30) Foreign Application Priority Data
Dec. 8, 2005 (DE) 20 2005 019 313.5

(51) Int. Cl. B05C 19/00; B05B 7/06

(52) U.S. Cl. 118/309; 118/308; 118/313

(57) ABSTRACT

The powder coating booth with one or more powder spray guns for coating work pieces with powder has first suction openings arranged below the powder spray guns. In addition the booth has second suction openings, which are arranged above the powder spray guns horizontally distributed along the longitudinal side of the booth.

### TECHNICAL FIELD

The invention relates to a booth for coating work pieces with powder.

### BACKGROUND OF THE INVENTION

For coating a work piece, like for example a plate or a cabinet, with powder, the powder is applied in a powder coating booth with the help of one or more powder spray guns on the work piece to be coated. In order to improve the adhesion of the powder on the work piece, the powder can be charged electrostatically. However it should be paid attention here that the concentration of the powder in the booth does not exceed a specific concentration, since otherwise there is a danger of explosion. For this reason, sucking off the air in the booth can keep the concentration of powder sufficiently low. In addition this generates a low pressure in the booth, which ensures that none of the powder is escaping from the booth.

A powder coating booth is known from the state of the art DE 103 50 332 A1, wherein several flaps arranged parallel to each other are provided above the booth bottom, which can be swiveled between a partial open position and a total open position. Depending on how far the flaps are opened, a more or less large gap forms, through which the surplus powder can be sucked off during the coating operation. The surplus powder, which deposits on the upper side of the flap, falls due to the gravitational force in the suction shaft if the flaps are fully opened and is carried away from there. This embodiment has the disadvantage that the high flowing speed of the air in the bottom area near the extremity of the pistol and in the lower area of the work piece considerably affects the powder cloud. The airflow deflects the powder cloud downward and sucks it off partially, which altogether affects the coating quality negatively.

In addition, a powder coating booth is known from the state of the art U.S. Pat. No. 6,821,346 B2, wherein an intermediate bottom is inserted. The intermediate bottom has insertion plates provided with slits, below which a suction channel is arranged. The powder air mixture is transported from the booth into the suction channel via the slits provided into the insertion pates and from there definitely out of the booth. In addition a vertical suction pipe is provided on one side of the booth wall and such vertical suction pipe has several suction slits vertically arranged one upon the other on the inside of the booth. Additional air is sucked off from the booth via the suction slits. This embodiment also has the disadvantage that the uneven suction of the air from the booth causes a partially too high motion speed of the powder cloud. As a result the powder cloud is deflected, before it reaches the work piece, and sucks off partially, which again negatively affects the coating quality.

### SUMMARY OF THE INVENTION

An object of the invention is therefore to indicate a powder coating booth, wherein the flow speed of the air in the booth is as constant as possible.

Another object of the invention consists in that the suction of the air existent in the booth does not negatively affect the coating process. Rather, it should be ensured that the suction of the air improves the coating process.

The powder coating booth according to the invention with one or more powder spray guns for coating work pieces with powder has first suction openings arranged below the powder spray guns. In addition the booth has second suction openings, which are arranged horizontally distributed along the longitudinal side of the booth above the powder spray guns.

In an embodiment of the powder coating booth according to the invention the second suction openings are arranged in the transition area between the booth ceiling and booth sidewall.

In another embodiment of the powder coating booth according to the invention the components of the suction are dimensioned in such a way that more air is sucked off via the second suction openings than via the first suction openings. In particular, the dimensioning of the suction openings and of the suction channels plays an important role here.

Advantageously the second suction openings are arranged directly above the powder spray guns in the case of the powder coating booth. So the gravitational force, to which the powder cloud is exposed, can be counteracted and in that way the sinking speed of the powder cloud is reduced and the application efficiency is improved.

It can also be an advantage, if the opening widths of the second suction openings are different in the case of the powder coating booth according to the invention. This has the advantage that there where the effect on the powder cloud is low, the sucked off airflow can be bigger than there where the effect on the powder cloud is considerable. Consequently the necessary total airflow, which is sucked off from the booth, can be maintained without affecting the powder cloud.

Moreover, suction pipes can be provided in the bottom area of the booth in the case of the powder coating booth according to the invention. In addition suction channels can be provided, via which the second suction openings are connected to the suction pipes.

It is further recommended for solving the object that the suction channels have the same cross-section as the second suction openings in the case of the powder coating booth according to the invention. This has particularly the advantage that the flow speed of the powder air mixture is basically consistent in the suction openings and the suction channels and thus a deposit of the sucked off powder on the suction channels is avoided.

In another embodiment of the powder coating booth according to the invention, the suction channels are arranged in the booth sidewalls. As a result place and material can be saved.

Finally one or more of the suction pipes can be connected to a powder recovery equipment and/or a filter unit in the case of the powder coating booth according to the invention. The powder recovery equipment can be for example a cyclone.

### BRIEF DESCRIPTION OF THE DRAWINGS

Hereinafter the invention will be described in details with several embodiments with the help of 15 figures.

FIG. 1 shows a first possible embodiment of the powder coating booth according to the invention in a three-dimensional view.

FIG. 2 shows the first embodiment of the booth in a cross-section from the front.

FIG. 3 shows the first embodiment of the booth in the lateral view.

FIG. 4 shows the first embodiment of the booth in the top view.

FIG. 5 shows the first embodiment of the booth in the top view in cross-section.

FIG. 6 shows a second possible embodiment of the powder coating booth according to the invention in a three-dimensional view.

FIG. 7 shows the second embodiment of the booth in the cross-section from the front.

FIG. 8 shows the second embodiment of the booth in the lateral view.

FIG. 9 shows the second embodiment of the booth in the top view.

FIG. 10 shows the second embodiment of the booth in the top view in cross-section.

FIG. 11 shows a third possible embodiment of the powder coating booth according to the invention in a three-dimensional view.

FIG. 12 shows the third embodiment of the booth in the cross-section from the front.

FIG. 13 shows the third embodiment of the booth in the lateral view.

FIG. 14 shows the third embodiment of the booth in the top view.

FIG. 15 shows the third embodiment of the booth in the top view in cross-section.

### Detailed description of the Invention

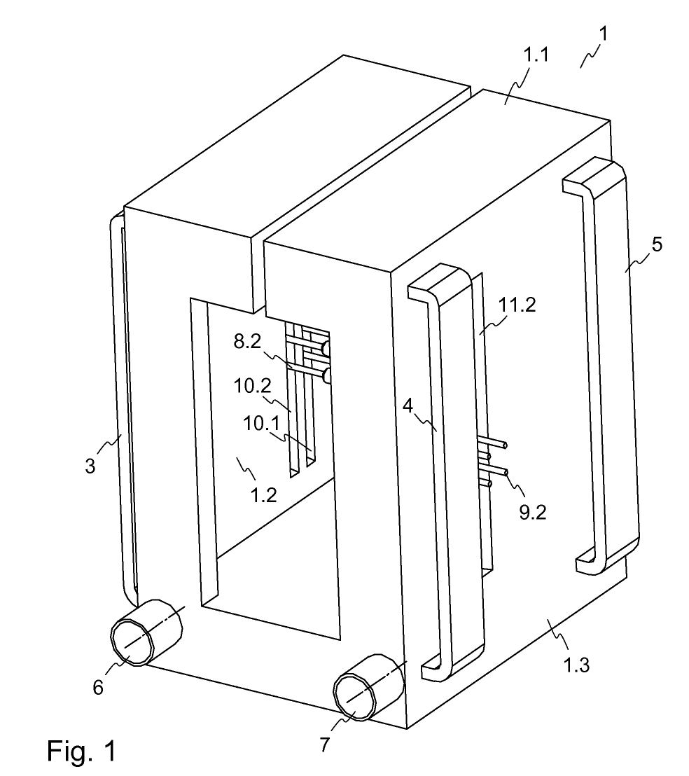

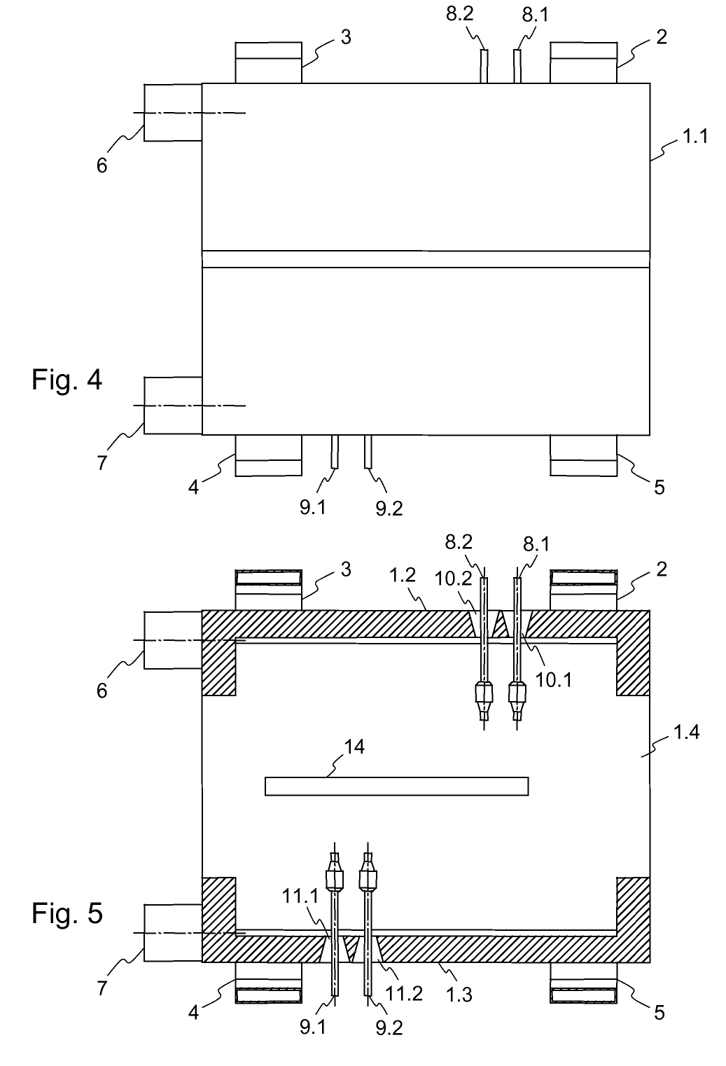

A first possible embodiment of a powder coating booth according to the invention is shown in the FIGS. 1 to 5.

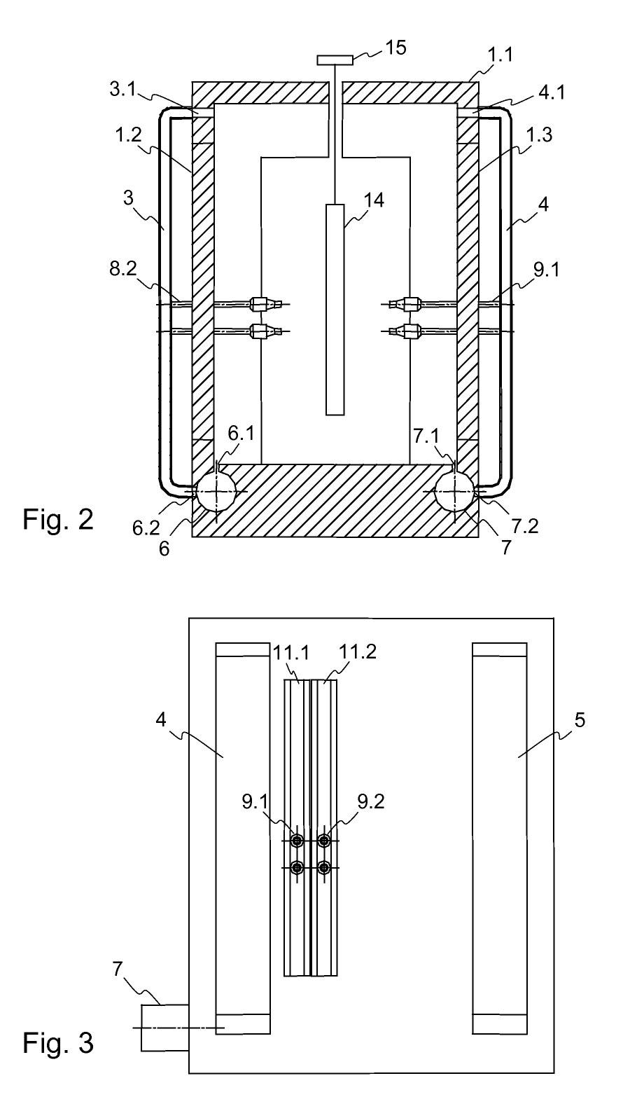

The powder coating booth 1, which is also called in short as booth in the following, shows on both sidewalls 1.3 and 1.3 respectively two vertical slits 10.1 and 10.2 and/or 11.1 and 11.2, through which the powder spray guns 8.1, 8.2 and 9.1, 9.2 can be led into the inside of the booth 1 to coat a work piece 14. For this purpose the work piece 14 is conveyed hanging on a conveyor belt or a conveyor track 15 in the booth 1, it is coated there and it is subsequently again conveyed out of the booth 1. For this purpose the booth 1 has an inlet opening in the front and an outlet opening at the back for the work pieces. Suction slits 2.1 to 5.1 are provided in the area between the booth ceiling 1.1 and the booth sidewall 1.2 and 1.3 and the air and surplus powder, i.e. the powder, which does not adhere to the work piece, are sucked off from inside the booth via these suction slits. The suction slits 2.1 and 3.1 are connected to the suction pipe 6 via two suction channels 2 and 3 and the suction slits 4.1 and 5.1 are connected to the suction pipe 7 via two suction channels 4 and 5. The suction pipes 6 and 7 have corresponding openings 6.2 and 7.2 for this purpose. In addition the suction pipes 6 and 7 have suction slits 6.1 and 7.1, which are arranged in the bottom area of the booth 1 so as to also suck off air and surplus powder from there. The lower suction slits or suction openings 6.1 and 7.1 can extend across the entire internal length of the booth 1. The upper suction openings 2.1 to 5.1 are arranged, as can be seen in FIG. 2, above the powder spray guns 8.1 to 9.2 in the four corner areas of the booth 1.

If required, additional suction openings can be arranged horizontally distributed across the length of the booth between the suction openings 2.1 and 3.1 and/or 4.1 and 5.1, such additional suction openings are however not shown in the FIGS. 1 to 5. Advantageously the upper suction openings 2.1 and 3.1 are arranged to the left and right above the slits 10.1 and 10.2 as well as upper suction openings 4.1 and 5.1 are arranged to the left and right above the slits 11.1 and 11.2.

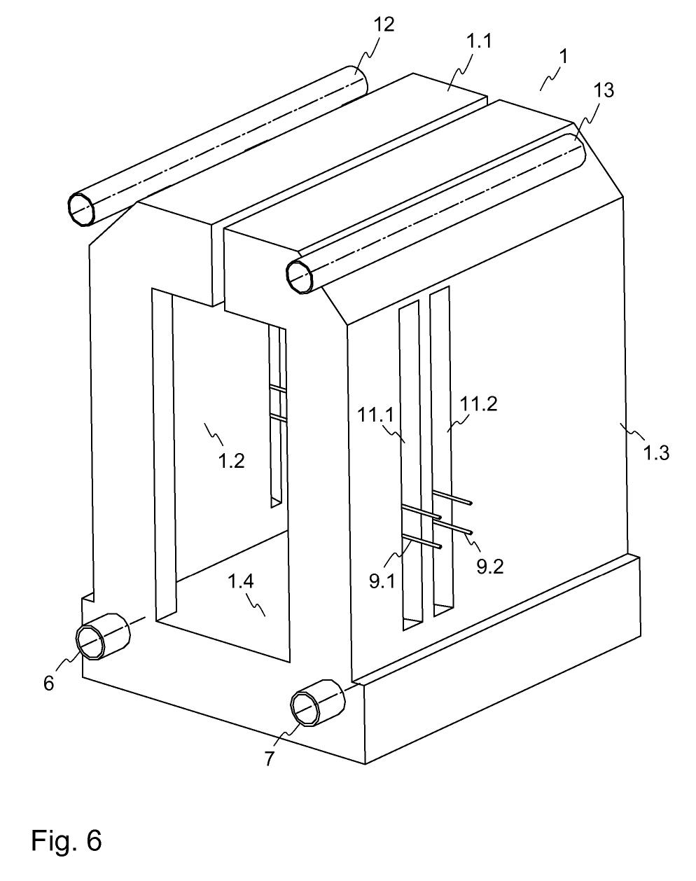

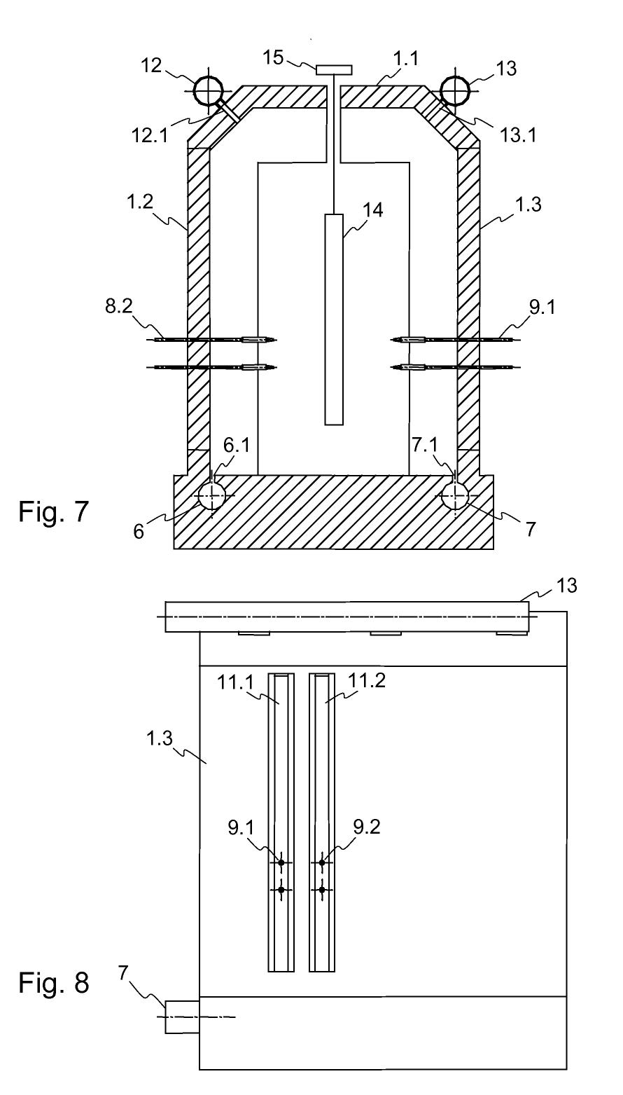

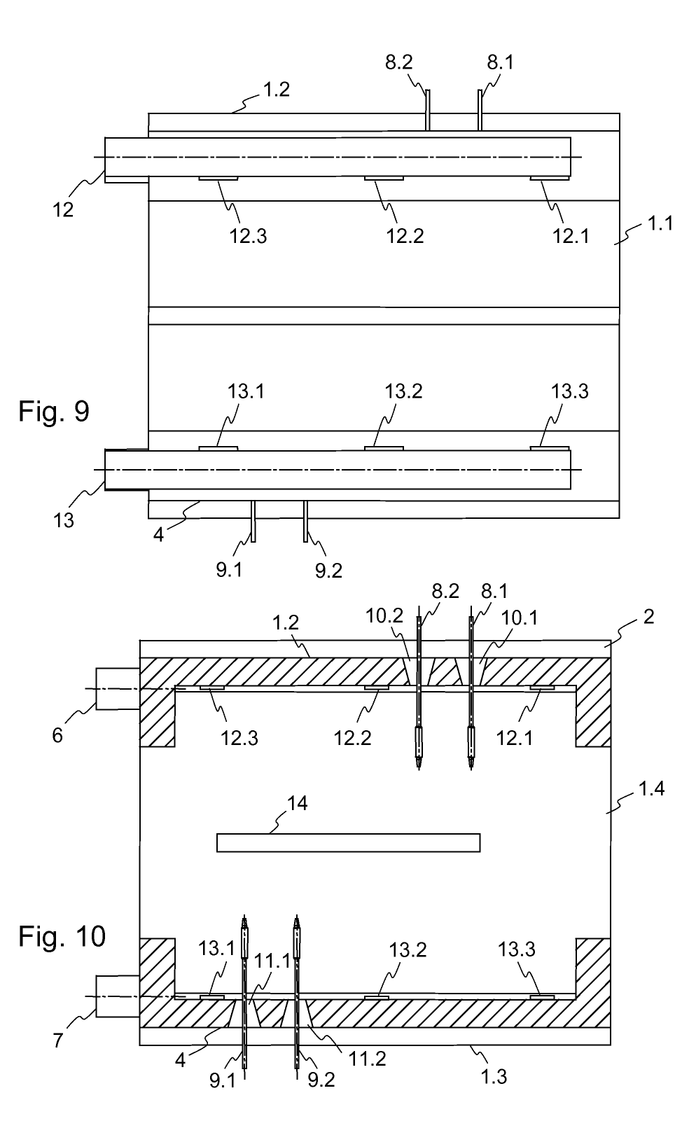

A second possible embodiment of a powder coating booth 1 according to the invention is shown in the FIGS. 6 to 10.

The second embodiment differs from the first embodiment in that the booth ceiling 1.1 is slanting in the transition area between booth ceiling 1.1 and sidewalls 1.2 and 1.3. Two suction pipes 12 and 13 are arranged in the slanting area of the booth ceiling 1.1. Each of the suction pipes 12 and 13 is connected to the booth interior via one or more suction openings 12.1 to 12.3 and 13.1 to 13.3.

The suction pipes 6, 7, 12 and 13 run parallel in the area of the booth 1 and can be subsequently combined into a common pipe and then led to a powder recovery unit.

The suction pipes 12 and 13 can also be connected to a separate powder recovery unit or directly to a suction unit with filter. It is possible to supply the air suctioned up via the suction pipes 12 and 13 with less amount of powder by bypassing the cyclone directly to the after filter. This discharges the cyclone, which is supplied with air and powder only from the lower suction pipes 6 and 7 in this embodiment. In addition, later, the distribution of the suction capacity can also be easily changed between the lower suction openings 6.1 and 7.1 and the upper suction openings 12.1-13.3, with two separate suctions.

In the second embodiment, three suction openings 12.1, 12.2 and 12.3 are connected to the suction pipe 12 and three suction openings 13.1, 13.2 and 13.3 are connected to the suction pipe 13, as all this can be seen in FIG. 10. This can reduce the amount of air sucked of per suction opening, what further reduces the effect on the powder cloud. Depending on the application, the individual suction openings 12.1, 12.2 and 12.3 and/or 13.1, 13.2 and 13.3 can have different cross-sections, i.e. different opening widths. This can generate airflows with varied strength at different points in the upper booth area. The dimensioning of the opening widths can be adjusted to the technical requirements in order to take into account for example the arrangement of the spray guns 8.1 to 9.2.

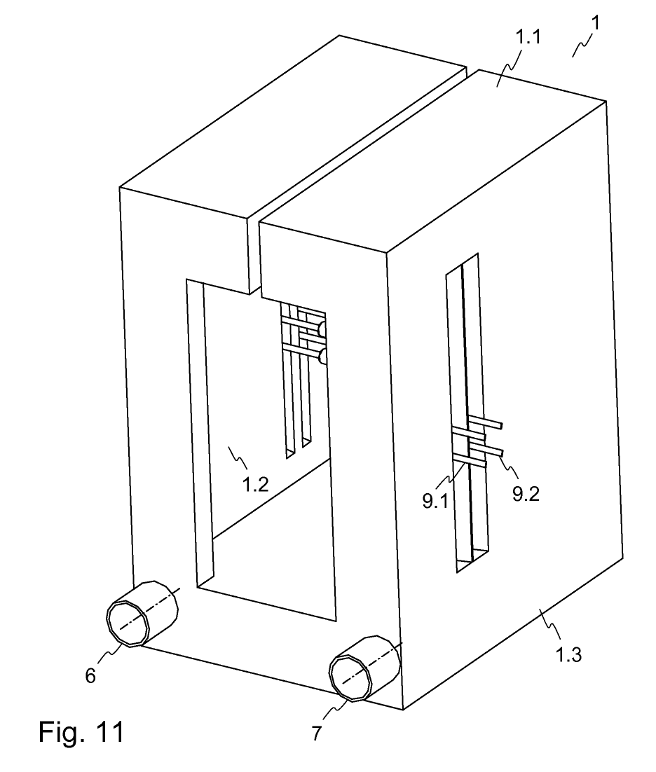

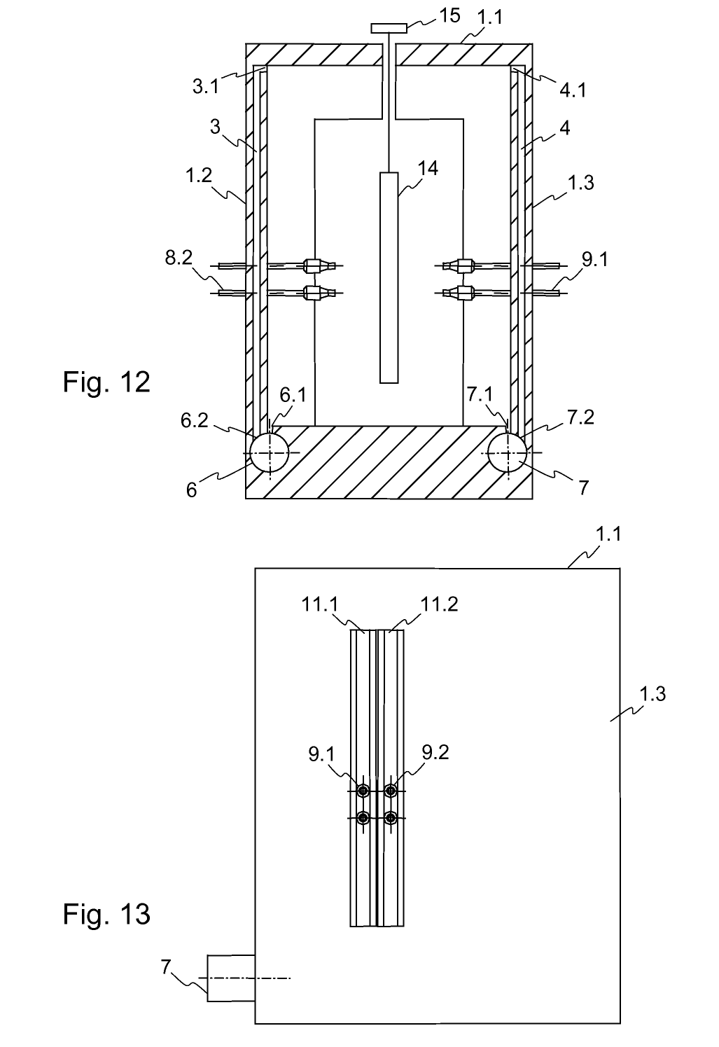

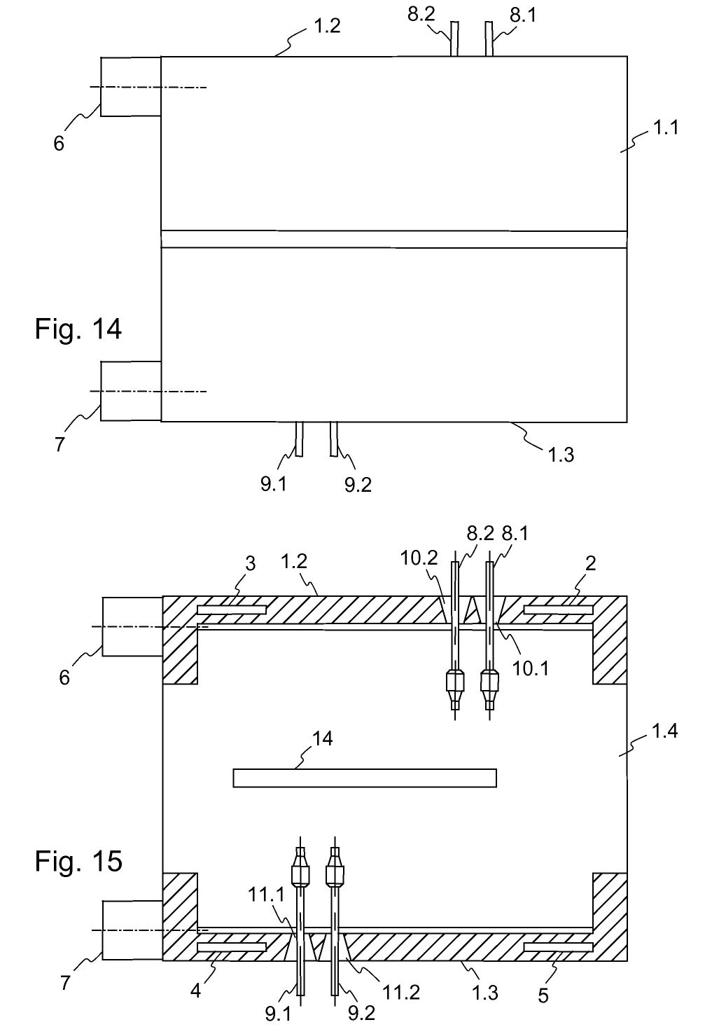

A third possible embodiment of a powder coating booth 1 according to the invention is shown in the FIGS. 11 to 15.

The third embodiment differs from the first embodiment shown in the FIGS. 1 to 5 in that the suction channels 2 to 5 are integrated into the booth walls 1.2 and 1.3.

In principle the sinking of the powder cloud as a result of the gravitational force can be slowed by arranging the upper suction openings directly above the powder spray guns and by generating such an airflow, which is directed against the gravitational force. Altogether this has a positive influence on the application efficiency.

The suction channels 2.1 to 5.1 can be developed in such a way that they can be opened for cleaning. For this purpose they can be equipped with a door or a flap on one side. In the third embodiment according to the FIGS. 11 to 15 the doors can be an integral part of the booth sidewalls 1.2 and 1.3.

The preceding description of the embodiments according to the present invention is used only for illustrative purposes and not for the purpose of restricting the invention. Different alterations and modifications are possible within the framework of the invention without leaving the scope of the invention and its equivalents.

### LIST OF REFERENCE SYMBOLS

1 Booth
1.1 Booth ceiling
1.2 Sidewall
1.3 Sidewall
1.4 Booth bottom
2 Vertical suction channel
3 Vertical suction channel
3.1 Suction opening
4 Vertical suction channel
4.1 Suction opening
5 Vertical suction channel
6 Horizontal suction channel
6.1 Inlet opening
6.2 Inlet opening
7 Horizontal suction channel
7.1 Inlet opening
7.2 Inlet opening
8.1 Spray gun
8.2 Spray gun
9.1 Spray gun
9.2 Spray gun
10.1 Slit
10.2 Slit
11.1 Slit
11.2 Slit
12 Horizontal suction channel
12.1 Suction opening
13 Horizontal suction channel
13.1 Suction opening
14 Work piece
15 Conveyor belt/Conveyor track

1. A powder coating booth, comprising:
one or more powder spray guns for coating work pieces with powder,
first suction openings arranged below the powder spray guns, and
second suction openings, which are arranged above the powder spray guns horizontally distributed along the longitudinal side of the booth.

2. A powder coating booth according to claim 1,
wherein the second suction openings are arranged in the transition area between the booth ceiling and booth sidewall.

3. A powder coating booth according to claim 1,
wherein the suction is developed in such a way that more air is sucked off via the second suction openings than via the first suction openings.

4. A powder coating booth according to claim 1,
wherein the second suction openings are arranged directly above the powder spray guns.

5. A powder coating booth according to claim 1,
wherein the opening widths of the second suction openings are of different size.

6. A powder coating booth according to claim 1,
wherein suction pipes are provided in the booth bottom area, and
wherein suction channels are provided, which connect the second suction openings to the suction pipes.

7. A powder coating booth according to claim 6,
wherein the suction channels have the same cross-section as the second suction openings.

8. A powder coating booth according to claim 1,
wherein the suction channels are developed in such a way that they can be opened.

9. A powder coating booth according to claim 8,
wherein the suction channels are arranged in the booth sidewalls.

10. A powder coating booth according to claim 1,
wherein one or more of the suction pipes are connected to powder recovery equipment and/or to a filter unit.
